(19) United States
(12) Patent Application Publication
(10) Pub. No.: US 2024/0269510 A1
(43) Pub. Date: Aug. 15, 2024

(54) POSITION ESTIMATION METHOD, POSITION ESTIMATION DEVICE, AND PROGRAM

(71) Applicant: NIPPON TELEGRAPH AND TELEPHONE CORPORATION, Tokyo (JP)

(72) Inventors: Seiichi KONYA, Tokyo (JP); Kenya SUZUKI, Tokyo (JP); Takashi MIYATAKE, Tokyo (JP); Taiji NAKAMURA, Tokyo (JP); Keisuke HASEGAWA, Tokyo (JP)

(73) Assignee: NIPPON TELEGRAPH AND TELEPHONE CORPORATION, Tokyo (JP)

(21) Appl. No.: 18/565,866

(22) PCT Filed: Jun. 2, 2021
(86) PCT No.: PCT/JP2021/021086

§ 371 Date: Nov. 30, 2023

(51) Int. Cl. A63B 24/00; A63B 102/04; G06T 7/20; G06T 7/70

(52) U.S. Cl. CPC A63B 24/0021; G06T 7/20; G06T 7/70; A63B 2024/0034; A63B 2102/04; A63B 2220/05; G06T 2207/30221

(57) ABSTRACT

A position estimation method according to the present disclosure includes a step of extracting an image of a moving object from a captured image obtained by imaging a predetermined imaging range including the moving object from a first direction, a step of estimating a direction of the moving object by matching a plurality of images viewed from the first direction with the extracted image of the moving object, the moving object having different inclinations in a second direction orthogonal to the first direction and in a third direction orthogonal to the first direction and the second direction, and a step of estimating a position of the moving object in the second direction and the third direction from the captured image, and estimating a position of the moving object in the first direction based on the estimated positions in the second direction and the third direction and the estimated change in the direction of the moving object.

### TECHNICAL FIELD

The present disclosure relates to a position estimation method, a position estimation device, and a program.

### BACKGROUND ART

A position estimation method for estimating a three-dimensional position of an object in a captured image from the captured images captured by two imaging devices having different angles is described in NPL 1. FIG. 8 is a diagram illustrating the position estimation method described in NPL 1.

As illustrated in FIG. 8, in the position estimation method described in NPL 1, an image of an object 1 is captured by two imaging devices having different angles. Specifically, as illustrated in FIG. 8, an image of the object 1 is captured from a Z-direction and an X-direction orthogonal to the Z-direction. A position x1 of the object 1 in the X-direction and a position y1 of the object in the Y-direction orthogonal to the X-direction and the Z-direction are estimated from a captured image P1 captured from the Z-direction. In addition, a position y2 of the object 1 in the Y-direction and a position z2 of the object 1 in the Z-direction are estimated from a captured image P2 captured from the X-direction. Then, a three-dimensional position of the object 1 is estimated by combining a two-dimensional position (x1, y1) estimated from the captured image P1 and a two-dimensional position (y2, z2) estimated from the captured image P2. By repeating such processing, for example, a three-dimensional position of a moving object such as a shuttlecock during a badminton game can be estimated.

### CITATION LIST

### Non Patent Literature

[NPL 1] Jan Erik Solem, “Practical computer vision,” Ohmsha, Ltd, Mar. 21, 2013

### SUMMARY OF INVENTION

### Technical Problem

In the position estimation method described in NPL 1, at least two imaging devices are required, and it is sometimes difficult to install a plurality of imaging devices so as to be able to image at different angles. Further, in the position estimation method described in NPL 1, since a plurality of imaging devices are used, calibration may be difficult if a performance difference between the plurality of imaging devices is large. As described above, the position estimation method described in NPL 1 has a problem that it takes time and effort to estimate the position of the object.

An object of the present disclosure made in view of the above-mentioned problems is to provide a position estimation method, a position estimation device, and a program capable of easily estimating a three-dimensional position of a moving object.

### Solution to Problem

In order to solve the above problem, a position estimation method according to the present disclosure is an estimation method for estimating a position of a moving object of which a shape viewed from a predetermined direction differs according to a direction, the method including a step of extracting an image of the moving object from a captured image obtained by imaging a predetermined imaging range including the moving object from a first direction, a step of estimating a direction of the moving object by matching a plurality of images viewed from the first direction with the extracted image of the moving object, the moving object having different inclinations in a second direction orthogonal to the first direction and in a third direction orthogonal to the first direction and the second direction, and a step of estimating a position of the moving object in the second direction and the third direction from the captured image, and estimates a position of the moving object in the first direction based on the estimated positions in the second direction and the third direction and the estimated change in the direction of the moving object.

In order to solve the above problem, a position estimation device according to the present disclosure is a position estimation device for estimating a position of a moving object of which a shape viewed from a predetermined direction differs according to a direction, the device including an extraction unit that extracts an image of the moving object from a captured image obtained by imaging a predetermined imaging range including the moving object from a first direction, a direction estimation unit that estimates a direction of the moving object by matching a plurality of images viewed from the first direction with the extracted image of the moving object, the moving object having different inclinations in a second direction orthogonal to the first direction and in a third direction orthogonal to the first direction and the second direction, and a position estimation unit that estimates a position of the moving object in the second direction and the third direction from the captured image, and estimating a position of the moving object in the first direction based on the estimated positions in the second direction and the third direction and the change in the direction of the moving object estimated by the direction estimation unit.

In addition, to solve the problems described above, a program according to the present disclosure causes a computer to function as the position estimation device described above.

### Advantageous Effects of Invention

According to the position estimation method, the position estimation device, and the program according to the present disclosure, it is possible to more easily estimate a three-dimensional position of a moving object.

### BRIEF DESCRIPTION OF DRAWINGS

FIG. 1 is a diagram illustrating a configuration example of a position estimation device according to an embodiment of the present disclosure.

FIG. 2 is a diagram for illustrating a captured image input to an input unit illustrated in FIG. 1

FIG. 3 is a flow chart illustrating an example of an operation of a position estimation device illustrated in FIG. 1.

FIG. 4 is a diagram for illustrating an operation of an extraction unit illustrated in FIG. 1.

FIG. 5 is a diagram for illustrating a template image held by a direction estimation unit illustrated in FIG. 1.

FIG. 6 is a diagram for illustrating an operation of a setting unit illustrated in FIG. 1.

FIG. 7 is a diagram illustrating an example of a hardware configuration of the position estimation device illustrated in FIG. 1.

FIG. 8 is a diagram for illustrating a conventional position estimation method.

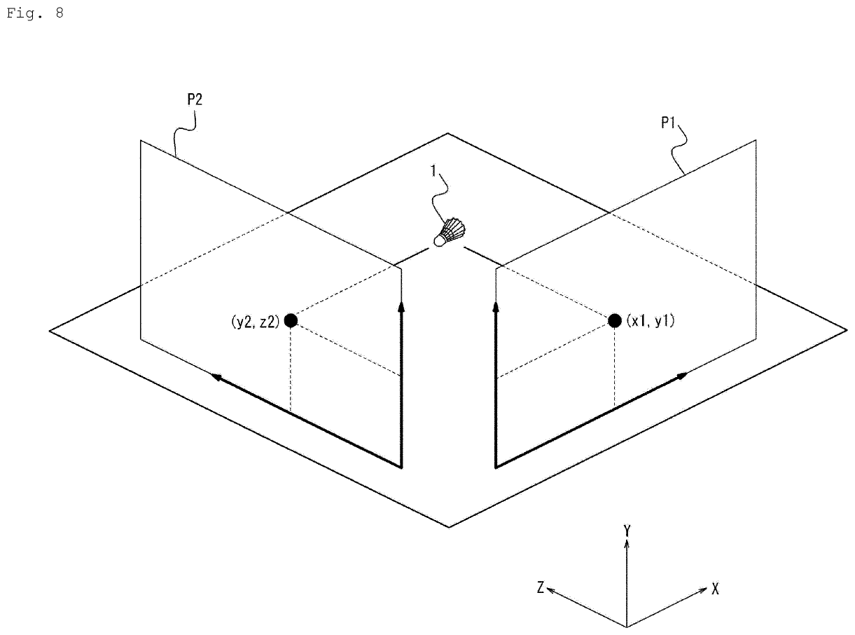

### DESCRIPTION OF EMBODIMENTS

A description will be attached below of embodiments of the present disclosure with reference to the drawings.

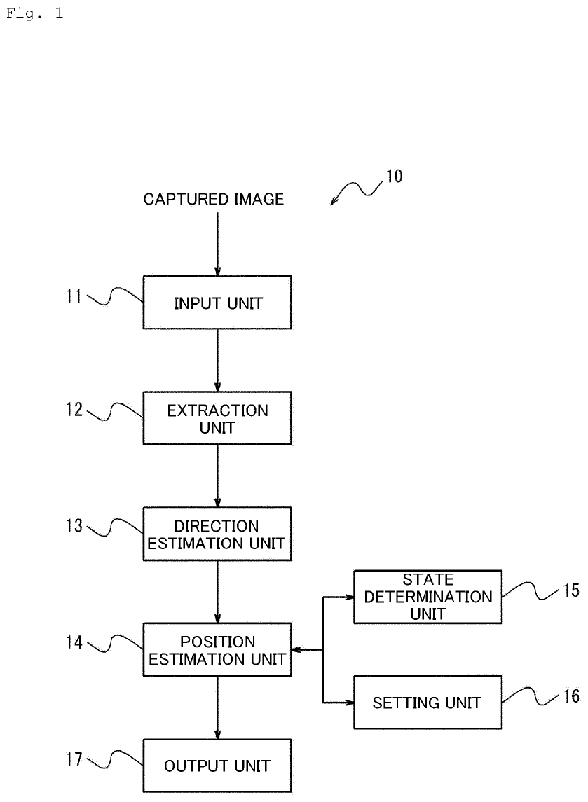

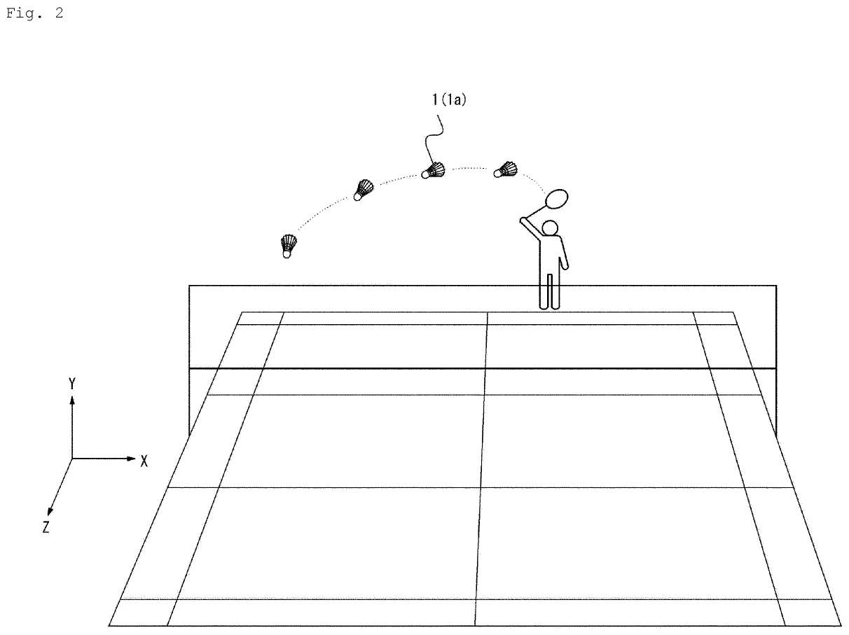

FIG. 1 is a diagram illustrating a configuration example of a position estimation device 10 according to an embodiment of the present disclosure. The position estimation device 10 according to the present embodiment estimates a three-dimensional position of an object 1 from a captured image obtained by imaging the object 1 by one imaging device. Hereinafter, the object 1 will be described with reference to an example of a moving object such as a shuttlecock 1a in a badminton game. In the following description, as illustrated in FIG. 2, when the lateral direction of the badminton court is defined as an X-direction (second direction), the vertical direction is defined as a Y-direction (third direction), and the depth direction is defined as a Z-direction (third direction). The X-direction, the Y-direction and the Z-direction are orthogonal to each other.

As illustrated in FIG. 1, the position estimation device 10 according to the present embodiment includes an input unit 11, an extraction unit 12, a direction estimation unit 13, a position estimation unit 14, a state determination unit 15, a setting unit 16, and an output unit 17.

As illustrated in FIG. 2, the input unit 11 images the badminton court from the Z-direction by an imaging device for imaging a prescribed imaging range, and inputs a captured image including a shuttlecock 1a as a moving object. The input unit 11 outputs the input captured image to the extraction unit 12.

The extraction unit 12 extracts the image of the shuttlecock 1a from the captured image output from the input unit 11, that is, the captured image obtained by imaging a predetermined imaging range including the shuttlecock 1a from the Z-direction, and outputs the image to the direction estimation unit 13. The details of the extraction of the image of the shuttlecock 1a from the captured image by the extraction unit 12 will be described later.

The direction estimation unit 13 estimates the direction of the shuttlecock 1a using the image of the shuttlecock 1a extracted by the extraction unit 12, and outputs the estimation result to the position estimation unit 14. Details of the estimation of the direction of the shuttlecock 1a by the direction estimation unit 13 will be described later.

The position estimation unit 14 estimates the positions of the shuttlecock 1a in the X-direction and the Y-direction from the captured image. The position estimation unit 14 estimates the position of the shuttlecock 1a in the Z-direction based on the estimated positions of the shuttlecock 1a in the X-direction and the Y-direction and the change of the direction of the shuttlecock 1a estimated by the direction estimation unit 13. The position estimation unit 14 estimates the positions of the shuttlecock 1a in the X-direction and the Y-direction from the captured image, and estimates the position of the shuttlecock 1a in the Z-direction from the estimation result and the change in the direction of the shuttlecock 1a, thereby estimating the three-dimensional position of the shuttlecock 1a. The position estimation unit 14 outputs the estimation results to the state determination unit 15, the setting unit 16, and the output unit 17.

The state determination unit 15 determines the state of movement of the shuttlecock 1a based on the movement amount of the position of the shuttlecock 1a estimated by the position estimation unit 14 for each predetermined period. The state of the movement of the shuttlecock 1a is, for example, by a player's serve, a state (service) in which the movement is started from a state in which the shuttlecock 1a is stationary, a state (flight) in which the shuttlecock 1a hit back by the player is advancing, and a state (shot) that the shuttlecock 1a hit by one player is hit back by the other player and the advancing direction of the shuttlecock 1a is changed in the Z-direction. The details of the determination of the state of movement of the shuttlecock 1a by the state determination unit 15 will be described later.

The setting unit 16 sets an initial position as a starting point of estimation of the position of the shuttlecock 1a in the Z-direction based on the captured image according to the state of movement of the shuttlecock 1a determined by the state determination unit 15. Specifically, when the state determination unit 15 determines that the shuttlecock 1a has started to move or that the traveling direction of the shuttlecock 1a in the Z direction has changed, the setting unit 16 sets the initial position, which is the starting point of the movement of the shuttlecock 1a or the change in the direction of travelling of the shuttlecock 1a based on the captured image.

The output unit 17 outputs the three-dimensional position of the shuttlecock 1a estimated by the position estimation unit 14, and the like.

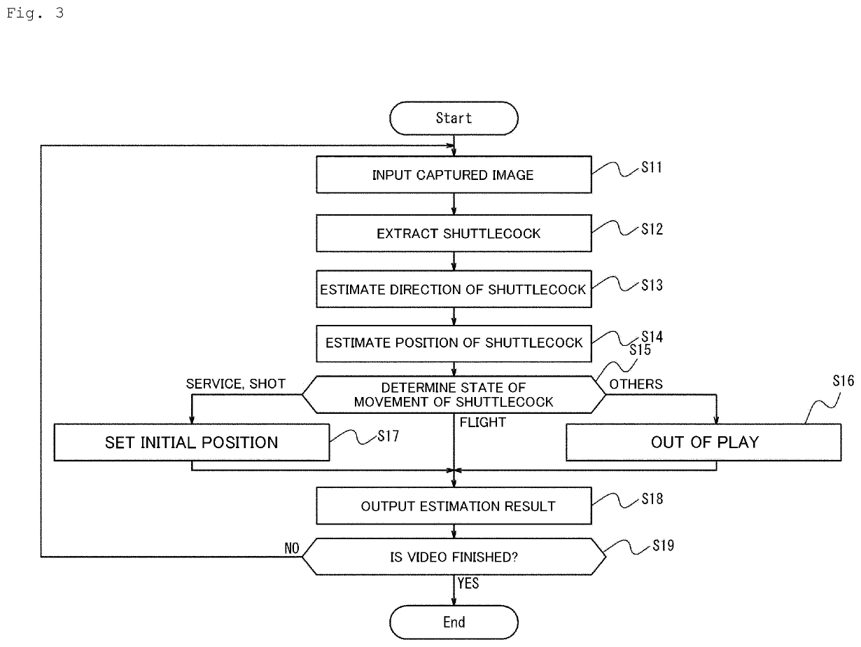

Next, an operation of the position estimation device 10 according to the present embodiment will be described. FIG. 3 is a flowchart illustrating an example of the operation of the position estimation device 10, and is a diagram for illustrating a position estimation method by the position estimation device 10 according to the present embodiment.

As illustrated in FIG. 2, a captured image obtained by imaging a court in which the badminton game is performed from the Z-direction is input to the input unit 11 (step S11).

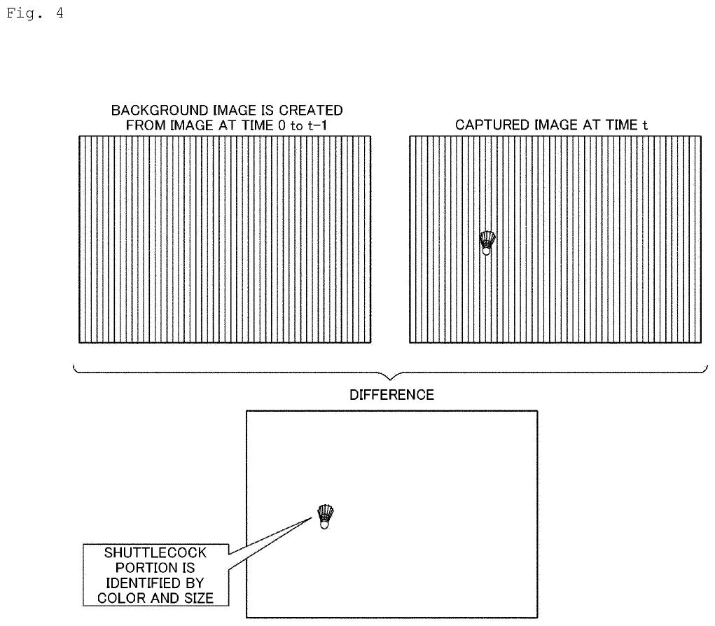

The extraction unit 12 extracts the shuttlecock 1a from the input captured image (step S12). The extraction of the shuttlecock 1a from the captured image by the extraction unit 12 will be described with reference to FIG. 4. In FIG. 4, description will be made using an example of extracting the shuttlecock 1a from the captured image at a certain time (time t).

The extraction unit 12 extracts the shuttlecock 1a from the captured image using, for example, a background difference method. Specifically, the extraction unit 12 creates a background image in which the shuttlecock 1a as a moving object does not exist from the captured image (captured image from time 0 to time t−1) before the time (t). The extraction unit 12 creates a difference image indicating a difference between the created background image and the captured image at the time t, and extracts the shuttlecock 1a from the difference image based on features such as the color and shape of the shuttlecock 1a.

Referring again to FIG. 3, the direction estimation unit 13 estimates the direction of the shuttlecock 1a from the image of the shuttlecock 1a extracted by the extraction unit 12 (step S13).

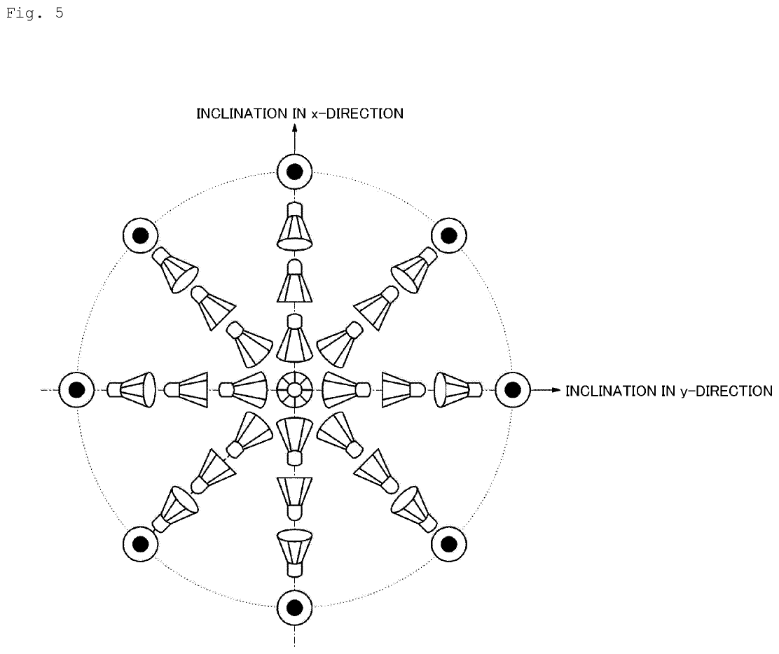

The shape of the shuttlecock 1a when viewed from a predetermined direction is different according to the direction of the shuttlecock 1a. The direction estimation unit 13 estimates the direction of the shuttlecock 1a from the extracted image of the shuttlecock 1a by utilizing the fact that the shape of the shuttlecock 1a to be observed differs according to the direction of the shuttlecock 1a. The direction estimation unit 13 holds a template image as an image obtained by viewing the shuttlecock 1a inclined at various angles in the X-direction and the Y-direction from the Z-direction in advance as illustrated in FIG. 5. The direction estimation unit 13 performs matching between the extracted image of the shuttlecock 1a and the held template image by, for example, a normalization cross-correlation method, the template image most similar to the image of the shuttlecock 1a is specified. The direction estimation unit 13 estimates the direction (inclination in the X-direction and the Y-direction) of the shuttlecock 1a in the specified template image as the direction of the shuttlecock 1a. In this way, the direction estimation unit 13 estimates the direction of the shuttlecock 1a by matching a plurality of images of the shuttlecock 1a having different inclinations in the X-direction and the Y-direction with the extracted image of the shuttlecock 1a.

The position estimation unit 14 estimates the positions of the shuttlecock 1a in the X-direction and the Y-direction from the captured image, and estimates the position of the shuttlecock 1a in the Z-direction based on the estimated positions of the shuttlecock 1a in the X-direction and the Y-direction and the change in the direction of the shuttlecock 1a estimated by the direction estimation unit 13 (step S14). In the following description, the positions of the shuttlecock 1a in the X-direction, the Y-direction, and the Z-direction estimated from the captured image at the time t−1 (first time) is (x(t−1), y(t−1), and z(t−1)), and the inclination of the shuttlecock 1a in the X- and Y-directions is (x(t−1), y(t−1)). Also, when the position of the shuttlecock 1a in the X-direction and the Y-direction estimated from the captured image at the time t (second time) is defined as (x(t), y(t)), the inclination of the shuttlecock 1a in the X-direction and the Y-direction is defined as (x(t−1), y(t−1)). The position estimation unit 14 estimates the position of the shuttlecock 1a in the Z-direction at the time t based on Equation 1 below.

$$\begin{matrix}[ Math . 1 ] & \\ z ( t ) = \{ \begin{matrix}\frac{x ( t ) - x ( t - 1 )}{{x}^{′} ( t ) + {x}^{′} ( t - 1 )} + \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) \neq 0 \\ 2 \cdot \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) \neq 0 \\ 2 \cdot \frac{x ( t ) - x ( t - 1 )}{{x}^{′} ( t ) + {x}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) = 0\end{matrix} & Equation 1\end{matrix}$$

The state determination unit 15 determines the state of movement of the shuttlecock 1a based on the movement amount of the position of the shuttlecock 1a estimated by the position estimation unit 14 for each predetermined period (step S15). In the following description, the positions of the shuttlecock 1a in the X-direction, the Y-direction and the Z-direction at the time t−2 are defined as (x(t−2), y(t−2), z(t−2)), when the position of the shuttlecock 1a in the X-direction, the Y-direction and the Z-direction at the time t−1 is defined as (x(t−1), y(t−1), z(t−1)), the positions of the shuttlecock 1a in the X-direction, the Y-direction, and the Z-direction are defined as (x(t), y(t), z(t)).

The state determination unit 15 calculates a change d(t−1) of the position at the time t−1 based on Equation 2 below.

$$d ( t - 1 ) = ( x ( t - 1 ) - x ( t - 2 ) , y ( t - 1 ) - y ( t - 2 ) , w ( t - 1 ) - z ( t - 2 ) ) \qquad Equation 2$$

That is, the state determination unit 15 calculates the movement amount of the shuttlecock 1a in a period from the time t−2 to the time t−1 as the change d(t−1) of the position at the time t−1.

The state determination unit 15 calculates a change d(t) of the position at the time t based on Equation 3 below.

$$d ( t ) = ( x ( t ) - x ( t - 1 ) , y ( t ) - y ( t - 1 ) , Z ( t ) - z ( t - 1 ) ) \qquad Equation 3$$

That is, the state determination unit 15 calculates the movement amount of the shuttlecock 1a in a period from the time t−1 to the time t as the change d(t) of the position at the time t.

The state determination unit 15 determines the state of movement of the shuttlecock 1a based on the change d(t−1) of the position at the time t−1 and the change d(t) of the position at the time t. Specifically, in a case where the change d(t−1) at time t−1 is less than the threshold K₀ (0<K₀) and the change d(t) at time t is greater than K₁ (0<K₁), that is, in a case where Equation 4 below is satisfied, the state determination unit 15 determines that the state of movement of the shuttlecock 1a is service (a state in which the shuttlecock 1a starts moving from a stationary state due to a serve by the player).

$$\vert d ( t - 1 ) \vert < {K}_{0} ∧ \vert d ( t ) \vert > {K}_{1} \qquad Equation 4$$

In addition, in a case where the change d(t−1) at the time t−1 and the change d(t) at the time t are greater than a threshold K₁ and signs of values in the Z-direction are different, that is, when Equation 5 below is satisfied, the state determination unit 15 determines that the state of movement of the shuttlecock 1a is a shot (the state in which the shuttlecock 1a shot by one player is shot back by the other player and the advancing direction of the shuttlecock 1a is changed in the Z-direction).

$$\vert d ( t - 1 ) \vert > {K}_{1} ∧ \vert d ( t ) \vert > {K}_{1} ∧ z ( t - 1 ) \cdot z ( t ) < - {K}_{2} \qquad Equation 5$$

In addition, in a case where the change d(t−1) at the time t−1 and the change d(t) at the time t are greater than the threshold K₁ and the values in the Z-direction are different from each other, that is, when Equation 6 below is satisfied, the state determination unit 15 determines that the movement state of the shuttlecock 1a is a flight (the state where the shuttlecock 1a hit by the player is advancing).

$$\vert d ( t - 1 ) \vert > {K}_{1} ∧ \vert d ( t ) \vert > {K}_{1} ∧ d ( t - 1 ) \cdot dt / \vert d ( t - 1 ) \vert \cdot \vert d ( t ) \vert > {K}_{3} \qquad Equation 6$$

In addition, the state determination unit 15 determines that the movement state of the shuttlecock 1a is out-of-play (the shuttlecock 1a is moving out of the game) in a case where none of Equations 4 to 6 is satisfied (step S16).

Note that in Equation 5, 0<K₂<1. In Equation 6, an expression of 0<K₃<1 is established. In Equations 4 to 6, “| |” indicates the size of the vector, and “ . . . ” indicates the inner product of the vector.

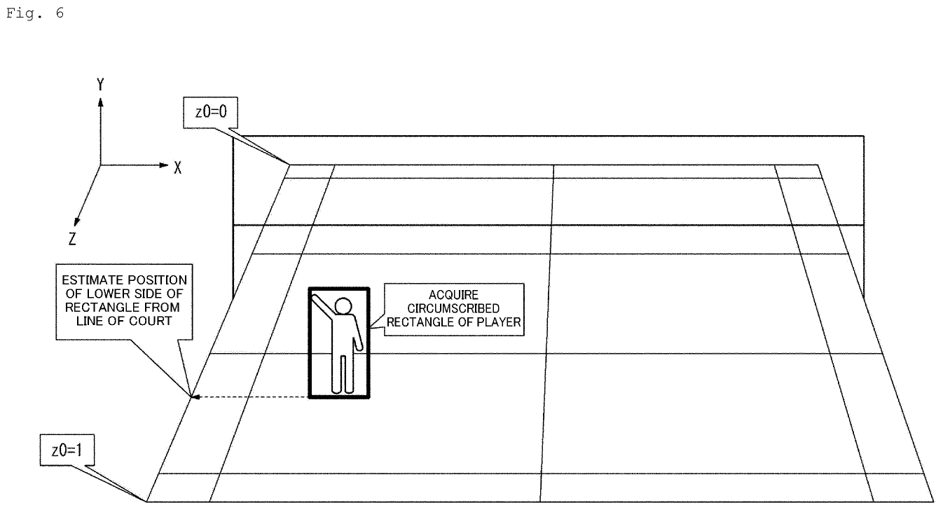

When it is determined that the state of movement of the shuttlecock 1a is a service or a shot, the setting unit 16 sets an initial position which is a start point of movement of the shuttlecock 1a or change in the traveling direction in the Z-direction based on the captured image (step S17). Setting of the initial position by the setting unit 16 will be described with reference to FIG. 6.

The setting unit 16 sets coordinates at a place where the position in the Z-direction is known, for example, in the captured image at the time when it is determined that the state of movement of the shuttlecock 1a is a service or a shot. In the example illustrated in FIG. 6, the setting unit 16 sets a coordinate z0 of the line on the nearest side among the lines extending in the X-direction of the badminton court to 1, and sets the coordinate z1 of the line on the innermost side to zero.

Next, the setting unit 16 acquires the circumscribed rectangle of a player who hits the shuttlecock 1a (a player who hits a serve or a player who returns the shuttlecock 1a) from the captured image using an arbitrary object extraction technique or the like. Then, the setting unit 16 estimates the position in the Z-direction of the player who hits the shuttlecock 1a based on the set coordinates in the Z-direction and the position of the lower side (the side on the front side in the Z-direction) of the acquired circumscribed rectangle. The setting unit 16 sets the estimated position of the player as the initial position of the position of the shuttlecock 1a in the Z-direction.

When the initial position is set by the setting unit 16, the position estimation unit 14 estimates the position of the shuttlecock 1a in the Z-direction with the set initial position as a starting point. In addition, when the state determination unit 15 determines that the state of movement of the shuttlecock 1a is a flight, the position estimation unit 14 estimates the position of the shuttlecock 1a in the Z-direction using the position of shuttlecock 1a at the previous time as the starting point. In addition, the position estimation unit 14 estimates that the position of the shuttlecock 1a is an exceptional value when the state determination unit 15 determines that the state of movement of the shuttlecock 1a is out-of-play.

Referring again to FIG. 3, the output unit 17 outputs an estimation result by the position estimation unit 14 (step S18). Therefore, in a case where it is determined that the state of movement of the shuttlecock 1a is a service, a shot, and a flight, the output unit 17 outputs the three-dimensional position (x(t), y(t), z(t)) of the shuttlecock 1a. In a case where the movement state of the shuttlecock 1a is determined to be out-of-play, the output unit 17 outputs that the three-dimensional position of the shuttlecock 1a is an exceptional value.

The position estimation device 10 repeats the processing (step S19) until the input video is finished (no image in the video is present).

As described above, the position estimation device 10 according to the present embodiment includes the extraction unit 12, the direction estimation unit 13, and the position estimation unit 14. The extraction unit 12 extracts an image of the moving object from a captured image obtained by imaging a predetermined imaging range including the moving object (shuttlecock 1a) from a first direction (Z-direction). The direction estimation unit 13 estimates a direction of a moving object having different inclinations in a second direction (X-direction) orthogonal to the first direction and a third direction (Y-direction) orthogonal to the first direction and the second direction by matching the moving object with a templet image that is a plurality of images viewed from the first direction and the extracted image of the moving object. The position estimation unit 14 estimates the positions of the moving object in the second direction and the third direction from the captured image. The position estimation unit 14 estimates the position of the moving object in the first direction based on the estimated positions in the second direction and the third direction and the estimated change in the direction of the moving object.

In addition, the position estimation method according to the present disclosure includes an extraction step S12, a direction estimation step S13, and a position estimation step S14. In the extraction step S12, an image of the moving object is extracted from a captured image obtained by imaging a predetermined imaging range including the moving object (shuttlecock 1a) from a first direction (Z-direction). In the direction estimation step S13, a direction of the moving object having different inclinations in a second direction (X-direction) orthogonal to the first direction and a third direction (Y-direction) orthogonal to the first direction and the second direction is estimated by matching the moving object with the templet image that is a plurality of images viewed from the first direction and the extracted image of the moving object. In the position estimation step S14, the positions of the moving object in the second direction and the third direction are estimated from the captured image. Then, in the position estimation step S14, the position of the moving object in the first direction is estimated based on the estimated positions in the second direction and the third direction and the estimated change in the direction of the moving object.

Since the three-dimensional position of the moving object can be estimated from the captured image captured from one direction, it is not necessary to use a plurality of imaging devices as in the conventional case. Therefore, since installation of the imaging device and calibration between the imaging devices are not required, the three-dimensional position of the moving object can be estimated more easily.

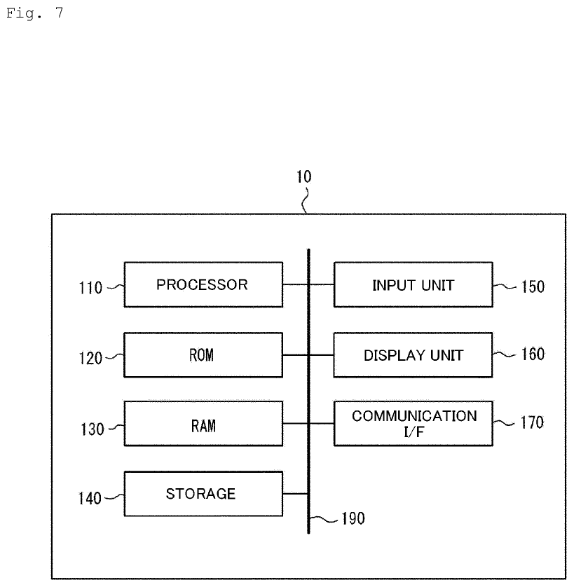

FIG. 7 is a diagram illustrating an example of a hardware configuration of the position estimation device 10 according to an embodiment of the present disclosure. FIG. 7 illustrates an example of the hardware configuration of the position estimation device 10 in a case where the position estimation device 10 is constituted by a computer capable of executing program instructions. The computer may be a general-purpose computer, a dedicated computer, a workstation, a personal computer (PC), an electronic note pad or the like. The program instructions may be program codes, code segments, or the like for executing necessary tasks.

As illustrated in FIG. 7, the position estimation device 10 has a processor 110, a read only memory (ROM) 120, a random access memory (RAM) 130, a storage 140, an input unit 150, a display unit 160, and a communication interface (I/F) 170. Each configuration is connected to each other via a bus 190 to be communicable with each other. Specifically, the processor 110 includes a central processing unit (CPU), a micro processing unit (MPU), a graphics processing unit (GPU), a digital signal processor (DSP), a System on a Chip (SoC), and the like, and may be constituted by a plurality of processors of the same kind or different kinds.

The processor 110 is a controller that controls each component and executes various arithmetic processing procedures. That is, the processor 110 reads a program from the ROM 120 or the storage 140 and executes the program using RAM 130 as a work area. The processor 110 performs control of each component and various types of arithmetic processing of the position estimation device 10 described above according to programs stored in the ROM 120 or the storage 140. In the present embodiment, the ROM 120 or the storage 140 stores a program for causing a computer to function as the position estimation device 10 according to the present disclosure. The program is read out and executed by the processor 110, so that each configuration of the position estimation device 10, that is, the input unit 11, the extraction unit 12, the direction estimation unit 13, the position estimation unit 14, the state determination unit 15, the setting unit 16, and the output unit 17 are realized.

The program may be provided by being stored on a non-transitory storage medium such as a Compact Disk Read Only Memory (CD-ROM), a Digital Versatile Disk Read Only Memory (DVD-ROM), or a Universal Serial Bus (USB) memory. Further, the program may be downloaded from an external device via a network.

The ROM 120 stores various programs and various types of data. The RAM 130 temporarily stores programs or data as a working area. The storage 140 is configured of a hard disk drive (HDD) or a solid state drive (SSD), and stores various programs including an operating system and various types of data. The ROM 120 and the storage 140 may store template images for estimating the directions of the shuttlecock 1a, for example.

The input unit 150 includes a pointing device such as a mouse and a keyboard, and is used for various inputs.

The display unit 160 is a liquid crystal display, for example, and displays various types of information. By adopting a touch panel system, the display unit 160 may also function as the input unit 150.

A communication interface 170 is an interface for communicating with another device (for example, an imaging device) and for example, a standard such as Ethernet (registered trademark), FDDI, or Wi-Fi (registered trademark) is used.

A computer can be suitably used to function as the units of the position estimation device 10 described above. Such a computer can be realized by storing a program describing the processing details for realizing the functions of each part of the position estimation device 10 in a storage unit of the computer and by causing a processor 110 of the computer to read and execute the program. That is, the program can cause the computer to function as the above-described position estimation device 10. Further, the program can be recorded on a non-temporary recording medium. The program may also be provided via a network.

The following additional remarks are disclosed in relation to the embodiments described above.

### (Supplementary Item 1)

A position estimation method for estimating a position of a moving object of which a shape viewed from a predetermined direction differs according to a direction, the method including
extracting an image of the moving object from a captured image obtained by imaging a predetermined imaging range including the moving object from a first direction,
estimating a direction of the moving object by matching a plurality of images viewed from the first direction with the extracted image of the moving object, the moving object having different inclinations in a second direction orthogonal to the first direction and in a third direction orthogonal to the first direction and the second direction, and
estimating a position of the moving object in the second direction and the third direction from the captured image, and estimating a position of the moving object in the first direction based on the estimated positions in the second direction and the third direction and the estimated change in the direction of the moving object.

### (Supplementary Item 2)

The position estimation device according to Supplementary Item 1, in which
when the position of the moving object in the second direction, the third direction, and the first direction estimated from the captured image at a first time is defined as (x(t−1), y(t−1), z(t−1)), and an inclination of the moving object is defined as (x′(t−1), y′(t−1)), and
when the position of the moving object in the second direction and the third direction estimated from the captured image at a second time is defined as (x(t), y(t)), and the inclination of the moving object is defined as (x′(t), y′(t)),
a position z(t) of the moving object in the first direction at the second time based on the following equation is estimated.

$$z ( t ) = \{ \begin{matrix}\frac{x ( t ) - x ( t - 1 )}{{x}^{′} ( t ) + {x}^{′} ( t - 1 )} + \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) \neq 0 \\ 2 \cdot \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) = 0 ∧ {y}^{′} ( t ) + {y}^{′} ( t - 1 ) \neq 0 \\ 2 \cdot \frac{x ( t ) - x ( t - 1 )}{{x}^{′} ( t ) + {x}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) = 0\end{matrix} \qquad [ Math . 2 ]$$

### (Supplementary Item 3)

The position estimation method according to Supplementary Item 1, further including
determining a state of movement of the moving object based on a movement amount of the estimated position of the moving object for each predetermined period, and
a step of setting an initial position which is a start point of the movement or the change in a traveling direction based on the captured image when it is determined that the moving object starts moving or the traveling direction of the moving object in the first direction has changed.

### (Supplementary Item 4)

A position estimation device for estimating a position of a moving object of which a shape viewed from a predetermined direction differs according to a direction, the device including:
a controller, in which
the controller
extracts an image of the moving object from a captured image obtained by imaging a predetermined imaging range including the moving object from a first direction,
estimates a direction of the moving object by matching a plurality of images viewed from the first direction with the extracted image of the moving object, the moving object having different inclinations in a second direction orthogonal to the first direction and in a third direction orthogonal to the first direction and the second direction, and
estimates a position of the moving object in the second direction and the third direction from the captured image, and estimating a position of the moving object in the first direction based on the estimated positions in the second direction and the third direction and the estimated change in the direction of the moving object.

### (Supplementary Item 5)

A non-transitory storage medium storing a program executable by a computer, the program causing the computer to function as the position estimation device according to Supplementary Item 4.

Although the above embodiment is described as a representative example, it is clear for those skilled in the art that many changes and replacement can be carried out within the gist and the scope of the present disclosure. Therefore, the embodiment described above should not be interpreted as limiting and the present invention can be modified and changed in various ways without departing from the scope of the claims. For example, a plurality of configuration blocks shown in the configuration diagrams of the embodiments may be combined to one, or one configuration block may be divided.

### REFERENCE SIGNS LIST

1 Object
1a Moving object
10 Position estimation device
11 Input
12 Extraction unit
13 Direction estimation unit
14 Position estimation unit
50 State determination unit
16 Setting unit
17 Output unit
110 PROCESSOR
120 ROM
130 RAM
140 Storage
150 Input unit
160 Output unit
170 Communication I/F
190 Bus

1. A position estimation method for estimating a position of a moving object of which a shape viewed from a predetermined direction differs according to a direction, the method comprising:
extracting an image of the moving object from a captured image obtained by imaging a predetermined imaging range including the moving object from a first direction, wherein the moving object is at a first position in the first direction, a second position in a second direction, and a third position in a third direction;
estimating a direction of the moving object by matching a plurality of images viewed from the first direction with the extracted image of the moving object, the moving object having different inclinations in the second direction orthogonal to the first direction and in the third direction orthogonal to the first direction and the second direction; and
estimating, based on the captured image, the second position of the moving object in the second direction and the third position in the third direction;
estimating the first position of the moving object in the first direction based on the estimated the first position according to the second direction and the third direction and the estimated change in the direction of the moving object; and
determining a three-dimensional position of the moving object based on the first position, the second position, and the third position.

2. The position estimation method according to claim 1, wherein
when the position of the moving object in the second direction, the third direction, and the first direction estimated from the captured image at a first time is defined as (x(t−1), y(t−1), z(t−1)) respectively, and an inclination of the moving object is defined as (x′(t−1), y′(t−1)), and
when the first position of the moving object in the second direction and the third direction estimated from the captured image at a second time is defined as (x(t), y(t)), and the inclination of the moving object is defined as (x′(t), y′(t)),
a position z(t) of the moving object in the first direction at the second time based on the following equation is estimated;
$$z ( t ) = \{ \begin{matrix}\frac{x ( t ) - x ( t - 1 )}{{x}^{′} ( t ) + {x}^{′} ( t - 1 )} + \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) \neq 0 \\ 2 \cdot \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) = 0 ∧ {y}^{′} ( t ) + {y}^{′} ( t - 1 ) \neq 0 \\ 2 \cdot \frac{x ( t ) - x ( t - 1 )}{{x}^{′} ( t ) + {x}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) = 0\end{matrix} . \qquad [ Math . 1 ]$$

3. The position estimation method according to claim 1, further comprising:
determining a state of movement of the moving object based on a movement amount of the estimated position of the moving object for each predetermined period; and
setting an initial position which is a start point of the movement or the change in a traveling direction based on the captured image when it is determined that the moving object starts moving or the traveling direction of the moving object in the first direction has changed.

4. A position estimation device for estimating a position of a moving object of which a shape viewed from a predetermined direction differs according to a direction, the device comprising a processor configured to execute operations comprising:
extracting an image of the moving object from a captured image obtained by imaging a predetermined imaging range including the moving object from a first direction;
estimating a direction of the moving object by matching a plurality of images viewed from the first direction with the extracted image of the moving object, the moving object having different inclinations in a second direction orthogonal to the first direction and in a third direction orthogonal to the first direction and the second direction;
estimating a position of the moving object in the second direction and the third direction from the captured image; and
estimating a position of the moving object in the first direction based on the estimated positions in the second direction and the third direction and the change in the direction of the moving object.

5. A computer-readable non-transitory recording medium storing a computer-executable program instructions for estimating a position of a moving object of which a shape viewed from a predetermined direction differs according to a direction, that when executed by a processor cause a computer to execute operations comprising:
extracting an image of the moving object from a captured image obtained by imaging a predetermined imaging range including the moving object from a first direction;
estimating a direction of the moving object by matching a plurality of images viewed from the first direction with the extracted image of the moving object, the moving object having different inclinations in a second direction orthogonal to the first direction and in a third direction orthogonal to the first direction and the second direction;
estimating a position of the moving object in the second direction and the third direction from the captured image; and
estimating a position of the moving object in the first direction based on the estimated positions in the second direction and the third direction and the change in the direction of the moving object.

6. The position estimation method according to claim 1, wherein the moving object includes a shuttlecock of a badminton sport.

7. The position estimation method according to claim 1, further comprising:
transmitting, the three-dimensional position of the moving object to an application configured to indicate the three-dimensional position of the moving object.

8. The position estimation method according to claim 1, further comprising:
determining, based at least on a change in the three-dimensional position of the moving object over time, a state of movement of the moving object.

9. The position estimation method according to claim 1, wherein the state of movement of the moving object includes at least one of:
a service,
a shot, or
a flight.

10. The position estimation method according to claim 2, further comprising:
determining a state of movement of the moving object based on a movement amount of the estimated position of the moving object for each predetermined period; and
setting an initial position which is a start point of the movement or the change in a traveling direction based on the captured image when it is determined that the moving object starts moving or the traveling direction of the moving object in the first direction has changed.

11. The position estimation device according to claim 4,
wherein
when the position of the moving object in the second direction, the third direction, and the first direction estimated from the captured image at a first time is defined as (x(t−1), y(t−1), z(t−1)) respectively, and an inclination of the moving object is defined as (x′(t−1), y′(t−1)), and
when the first position of the moving object in the second direction and the third direction estimated from the captured image at a second time is defined as (x(t), y(t)), and the inclination of the moving object is defined as (x′(t), y′(t)),
a position z(t) of the moving object in the first direction at the second time based on the following equation is estimated:
$$z ( t ) = \{ \begin{matrix}\frac{x ( t ) - x ( t - 1 )}{{x}^{′} ( t ) + {x}^{′} ( t - 1 )} + \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) \neq 0 \\ 2 \cdot \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) = 0 ∧ {y}^{′} ( t ) + {y}^{′} ( t - 1 ) \neq 0 \\ 2 \cdot \frac{x ( t ) - x ( t - 1 )}{{x}^{′} ( t ) + {x}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) = 0\end{matrix} \qquad [ Math . 2 ]$$

12. The position estimation device according to claim 4, the processor further configured to execute operations comprising:
determining a state of movement of the moving object based on a movement amount of the estimated position of the moving object for each predetermined period; and
setting an initial position which is a start point of the movement or the change in a traveling direction based on the captured image when it is determined that the moving object starts moving or the traveling direction of the moving object in the first direction has changed.

13. The position estimation device according to claim 4, wherein the moving object includes a shuttlecock of a badminton sport.

14. The position estimation device according to claim 4, the processor further configured to execute operations comprising:
transmitting, the three-dimensional position of the moving object to an application configured to indicate the three-dimensional position of the moving object.

15. The position estimation device according to claim 4, the processor further configured to execute operations comprising:
determining, based at least on a change in the three-dimensional position of the moving object over time, a state of movement of the moving object, wherein the state of movement of the moving object includes at least one of:
a service,
a shot, or
a flight.

16. The computer-readable non-transitory recording medium according to claim 5, wherein
when the position of the moving object in the second direction, the third direction, and the first direction estimated from the captured image at a first time is defined as (x(t−1), y(t−1), z(t−1)) respectively, and an inclination of the moving object is defined as (x′(t−1), y′(t−1)), and
when the first position of the moving object in the second direction and the third direction estimated from the captured image at a second time is defined as (x(t), y(t)), and the inclination of the moving object is defined as (x′(t), y′(t)),
a position z(t) of the moving object in the first direction at the second time based on the following equation is estimated:
$$z ( t ) = \{ \begin{matrix}\frac{x ( t ) - x ( t - 1 )}{{x}^{′} ( t ) + {x}^{′} ( t - 1 )} + \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) \neq 0 \\ 2 \cdot \frac{y ( t ) - y ( t - 1 )}{{y}^{′} ( t ) + {y}^{′} ( t - 1 )} + z ( t - 1 ) & {x}^{′} ( t ) + {x}^{′} ( t - 1 ) = 0 ∧ {y}^{′} ( t ) + {y}^{′} ( t - 1 ) \neq 0 \\ 2 \cdot \frac{x ( t ) - x ( t - 1 )}{{x}^{′} ( t ) + {x}^{′} ( t - 1 )} + z ( t - 1 ) & {x}^{′} ( t ) + {x}^{′} ( t - 1 ) \neq 0 ∧ {y}^{′} ( t ) + {y}^{′} ( t - 1 ) = 0\end{matrix} \qquad [ Math . 3 ]$$

17. The computer-readable non-transitory recording medium according to claim 5, the computer-executable program instructions when executed further causing the computer system to execute operations comprising:
determining a state of movement of the moving object based on a movement amount of the estimated position of the moving object for each predetermined period; and
setting an initial position which is a start point of the movement or the change in a traveling direction based on the captured image when it is determined that the moving object starts moving or the traveling direction of the moving object in the first direction has changed.

18. The computer-readable non-transitory recording medium according to claim 5, wherein the moving object includes a shuttlecock of a badminton sport.

19. The computer-readable non-transitory recording medium according to claim 5, the computer-executable program instructions when executed further causing the computer system to execute operations comprising:
transmitting, the three-dimensional position of the moving object to an application configured to indicate the three-dimensional position of the moving object.

20. The computer-readable non-transitory recording medium according to claim 5, the computer-executable program instructions when executed further causing the computer system to execute operations comprising:
determining, based at least on a change in the three-dimensional position of the moving object over time, a state of movement of the moving object, wherein the state of movement of the moving object includes at least one of:
a service,
a shot, or
a flight.
